(19) United States
(12) Patent Application Publication
(10) Pub. No.: US 2013/0008608 A1
(43) Pub. Date: Jan. 10, 2013

(54) PLASMA PROCESSING APPARATUS

(75) Inventors: Naoki MATSUMOTO, Sendai City (JP); Yasuhiro OTSUKA, Sendai City (JP)

(73) Assignee: TOKYO ELECTRON LIMITED, Tokyo (JP)

(21) Appl. No.: 13/542,068

(22) Filed: Jul. 5, 2012

(30) Foreign Application Priority Data
Jul. 7, 2011 (JP) 2011-151015
Jun. 12, 2012 (JP) 2012-132838

(51) Int. Cl. H05H 1/24; B44C 1/22

(52) U.S. Cl. 156/345.51

(57) ABSTRACT

The plasma processing apparatus includes a processing container, a gas supplying unit, an introducing unit, a holding member, and a focus ring. In a processing space defined by the processing container, plasma of a processing gas supplied from the gas supplying unit is generated by energy introduced from the introducing unit. The holding member for holding an object to be processed and a focus ring formed to surround a cross-section of the holding member are disposed in the processing space. A gap equal to or less than 350 μm is defined between the cross-section of the holding member and the focus ring.

### CROSS-REFERENCE TO RELATED PATENT APPLICATIONS

This application claims the benefit of Japanese Patent Applications No. 2011-151015, filed on Jul. 7, 2011, and No. 2012-132838, filed on Jun. 12, 2012, in the Japan Patent Office, the disclosures of which are incorporated herein in their entireties by reference.

### BACKGROUND OF THE INVENTION

1. Field of the Invention

The present invention relates to a plasma processing apparatus.

2. Description of the Related Art

A kind of plasma processing apparatus is disclosed in Patent Document 1. The plasma processing apparatus disclosed in Patent Document 1 includes a processing container, first and second electrodes, a high frequency power feeder, a processing gas supplying unit, a main dielectric material, a focus ring, and a peripheral derivative.

An electrostatic chuck including the main dielectric material, and the focus ring are attached to a main surface of the first electrode. The focus ring is attached to the main surface of the first electrode to cover a peripheral portion located outside of an area where the electrostatic chuck is disposed. The first electrode has an outer diameter even larger than a diameter of an object to be processed to obtain in-plane uniformity of intensity of plasma. The focus ring is provided to cover the peripheral portion of the first electrode to protect a surface of the first electrode against plasma.

In the plasma processing apparatus disclosed in Patent Document 1, after processing the object to be processed, an extraneous material may be generated and attached to an outer circumferential portion of the electrostatic chuck, and the like.

3. Prior Art Reference

(Patent Document 1) Japanese Laid-Open Patent Publication No. 2008-244274

### SUMMARY OF THE INVENTION

The present invention provides a plasma processing apparatus capable of preventing generation of an extraneous material.

According to an aspect of the present invention, a plasma processing apparatus includes a processing container which defines a processing space; a gas supplying unit which supplies a processing gas to the processing space; an introducing unit which introduces energy for generating plasma of the processing gas; a holding member which holds an object, has a surface formed of a dielectric material, and is provided inside the processing space; and a focus ring which is provided to surround a cross-section of the holding member, wherein a gap equal to or less than 350 μm is defined between the cross-section of the holding member and the focus ring.

While the plasma processing apparatus is being operated, the holding member and the focus ring are heated to a predetermined temperature. If the holding member and the focus ring are heated, the holding member and the focus ring are deformed due to thermal expansion rates of materials forming the holding member and the focus ring. Since the cross-section of the holding member is prevented from contacting the focus ring, a relatively large gap is generally set between the cross-section of the holding member and the focus ring. In the plasma processing apparatus, minute particles are generated due to plasma entering the gap between the cross-section of the holding member and the focus ring during a cleaning operation, and the like, and thus the minute particles may adhere to an outer circumferential portion of the holding member.

In a plasma processing apparatus according to an aspect of the present invention, a distance, that is, a gap, between the cross-section of the holding member and an inner circumference of the focus ring is set to be equal to or less than 350 μm, and thus plasma is prevented from entering the gap, thereby preventing generation of minute particles. Accordingly, an extraneous material adhering to the outer circumferential portion of the holding member may be prevented from being generated.

According to another aspect of the present invention, the focus ring includes a first area, including an inner circumference of the focus ring, and a second area positioned outside of the first area, the first area is provided along a surface extending from a top surface of the holding member or is provided below the extending surface, and the second area is provided above the top surface of the holding member.

According to the focus ring, when an object to be processed is held by the holding member, a gap between the cross-section of the holding member and the focus ring is covered by the object to be processed. Thus, plasma is prevented from entering the gap between the cross-section of the holding member and the focus ring, thereby preventing generation of minute particles.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic cross-sectional view of a plasma processing apparatus according to an embodiment of the present invention;

FIG. 2 is a plan view of a slot plate seen from a direction of an axial line X according to an embodiment of the present invention;

FIG. 3 is a plan view of an electrostatic chuck and a focus ring seen from a direction of an axial line X according to an embodiment of the present invention;

FIG. 4 is an enlarged partial cross-sectional view of an electrostatic chuck and a focus ring according to an embodiment of the present invention;

FIGS. 5A and 5B are cross-sectional views illustrating a factor resulting in generation of an extraneous material;

FIGS. 6A-6D are images of an electrostatic chuck and a focus ring according to a comparative example of the present invention; and

FIGS. 7A-7D are images of an electrostatic chuck and a focus ring according to an embodiment of the present invention.

### DETAILED DESCRIPTION OF THE INVENTION

Hereinafter, the present invention will be described in detail by explaining exemplary embodiments of the invention with reference to the attached drawings. Like reference numerals in the drawings denote like elements.

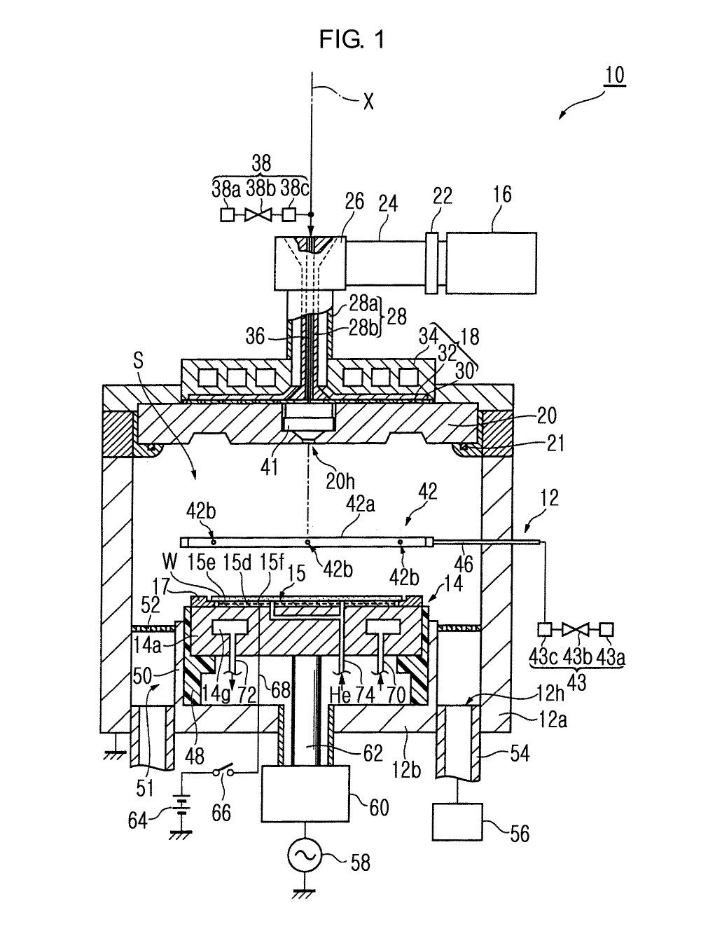

FIG. 1 is a schematic view of a plasma processing apparatus 10 according to an embodiment of the present invention. The plasma processing apparatus 10 of FIG. 1 includes a processing container 12, a stage 14, a microwave generator 16, an antenna 18, and a dielectric window 20. The plasma processing apparatus 10 is a microwave plasma processing apparatus for generating plasma by using microwaves propagated from the antenna 18. Alternatively, the plasma processing apparatus 10 may be an arbitrary plasma processing apparatus different from the microwave plasma processing apparatus.

The processing container 12 defines a processing space S for performing plasma processing on an object to be processed W. The processing container 12 may include a side wall 12a and a bottom portion 12b. The side wall 12a may have an approximately barrel shape extending in a direction of an axial line X, that is, a direction in which the axial line X extends. The bottom portion 12b is provided at a lower end of the side wall 12a. An exhaust hole 12h for exhaust is formed in the bottom portion 12b. An upper end of the side wall 12a is opened.

An opening of the upper end of the side wall 12a is closed by a dielectric window 20. An O-ring 21 may be interposed between the dielectric window 20 and the upper end of the side wall 12a. The processing container 12 may be firmly sealed by the O-ring 21.

The microwave generator 16 generates microwaves of 2.45 GHz. In the present embodiment of the present invention, the plasma processing apparatus 10 further includes a tuner 22, a waveguide 24, a mode converter 26, and a coaxial waveguide 28. Also, the microwave generator 16, the tuner 22, the waveguide 24, the mode converter 26, the coaxial waveguide 28, the antenna 18, and the dielectric window 20 constitute an introducing unit for introducing energy for generating plasma into the processing space S.

The microwave generator 16 is connected to the waveguide 24 via the tuner 22. The waveguide 24 is, for example, a rectangular waveguide. The waveguide 24 is connected to the mode converter 26, and the mode converter 26 is connected to an upper end of the coaxial waveguide 28.

The coaxial waveguide 28 extends in a direction of the axial line X. The coaxial waveguide 28 includes an outer conductor 28a and an inner conductor 28b. The outer conductor 28a has an approximately cylindrical shape extending in a direction of the axial line X. The inner conductor 28b is provided inside the outer conductor 28a. The inner conductor 28b has an approximately cylindrical shape extending in a direction of the axial line X.

The microwaves generated by the microwave generator 16 are guided to the mode converter 26 via the tuner 22 and the waveguide 24. The mode converter 26 converts a mode of the microwaves and supplies the microwaves after the mode conversion to the coaxial waveguide 28. The microwaves are supplied from the coaxial waveguide 28 to the antenna 18.

The antenna 18 radiates microwaves for plasma excitation based on the microwaves generated by the microwave generator 16. The antenna 18 may include a slot plate 30, a dielectric plate 32, and a cooling jacket 34.

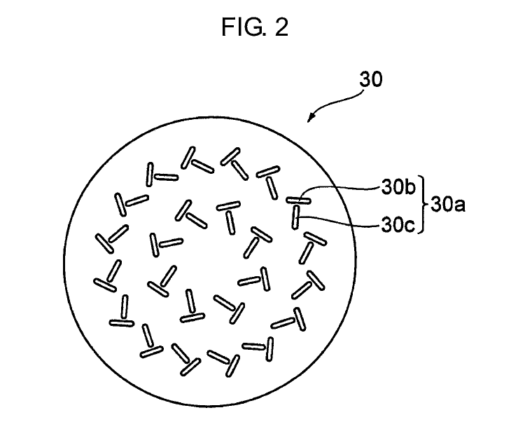

A plurality of slots are arranged in the slot plate 30 in a circumferential direction around the axial line X. FIG. 2 is a plan view of the slot plate 30 seen from a direction of the axial line X according to an embodiment of the present invention. In the present embodiment, as shown in FIG. 2, the slot plate 30 may be a slot plate constituting a radial line slot antenna. The slot plate 30 is formed of a conductive metal disc. A plurality of slot pairs 30a are formed in the slot plate 30. Each slot pair 30a includes a slot 30b and a slot 30c that extend in a direction in which the slot 30b and the slot 30c intersect each other or cross at right angles to each other. The plurality of slot pairs 30a are disposed spaced apart from one another in a radial direction and in a circumferential direction.

The dielectric plate 32 is provided between the slot plate 30 and a bottom surface of the cooling jacket 34. The dielectric plate 32 is formed of, for example, quartz, and has an approximately disc shape. A surface of the cooling jacket 34 may have conductivity. The cooling jacket 34 cools the dielectric plate 32 and the slot plate 30. Thus, a flow path for a coolant is formed inside the cooling jacket 34. A lower end of the outer conductor 28a is electrically connected to a top surface of the cooling jacket 34. Also, a lower end of the inner conductor 28b is electrically connected to the slot plate 30 via a hole formed in the middle of the cooling jacket 34 and the dielectric plate 32.

The microwaves guided from the coaxial waveguide 28 are propagated to the dielectric plate 32 and are introduced into the processing space S from the slots of the slot plate 30 via the dielectric window 20. The dielectric window 20 has an approximately disc shape and is formed of, for example, quartz. The dielectric window 20 is provided between the processing space S and the antenna 18. In the present embodiment, the dielectric window 20 is provided right under the antenna 18 in a direction of the axial line X.

In the present embodiment, a pipe 36 is provided in an inner hole of the inner conductor 28b of the coaxial waveguide 28. The pipe 36 may extend in a direction of the axial line X to be connected to a gas supplying unit 38.

The gas supplying unit 38 supplies a processing gas for processing the object to be processed W to the pipe 36. The processing gas supplied by the gas supplying unit 38 contains carbon. In the present embodiment, the processing gas is an etching gas, for example, CF₄ gas or CH₂F₂ gas. The gas supplying unit 38 may include a gas source 38a, a valve 38b, and a flow controller 38c. The gas source 38a is a gas source for supplying the processing gas. The valve 38b switches between supply and cut off of the processing gas from the gas source 38a. The flow controller 38c may be, for example, a mass flow controller, and controls flow of the processing gas supplied from the gas source 38a.

In the present embodiment, the plasma processing apparatus 10 may further include an injector 41. The injector 41 supplies gas from the pipe 36 to a through hole 20h formed in the dielectric window 20. The gas supplied to the through hole 20h formed in the dielectric window 20 is supplied into the processing space S.

In the present embodiment, the plasma processing apparatus 10 may further include a gas supplying unit 42. The gas supplying unit 42 supplies gas into the processing space S from a circumference of the axial line X in a space between the stage 14 and the dielectric window 20. The gas supplying unit 42 may include a pipe 42a. The pipe 42a annularly extends around the axial line X between the dielectric window 20 and the stage 14. A plurality of gas supply holes 42b are formed in the pipe 42a. The gas supply holes 42b are annularly arranged and opened toward the axial line X to supply gas supplied to the pipe 42a toward the axial line X. The gas supplying unit 42 is connected to a gas supplying unit 43 via a pipe 46.

The gas supplying unit 43 supplies a processing gas for processing the object to be processed W to the gas supplying unit 42. The processing gas supplied by the gas supplying unit 43 contains carbon, similar to the processing gas supplied by the gas supplying unit 38. In the present embodiment, the processing gas is an etching gas, for example, CF₄ gas or CH₂F₂ gas. The gas supplying unit 43 may include a gas source 43a, a valve 43b, and a flow controller 43c. The gas source 43a is a gas source of the processing gas. The valve 43b switches between supply and cut off of the processing gas from the gas source 43a. The flow controller 43c may be, for example, a mass flow controller, and controls flow of the processing gas supplied from the gas source 43a.

The stage 14 is provided to face the dielectric window 20 in a direction of the axial line X. The processing space S is interposed between the dielectric window 20 and the stage 14. The object to be processed W is held on the stage 14. In the present embodiment, the stage 14 may include a base 14a, an electrostatic chuck 15, and a focus ring 17.

The base 14a is supported by a barrel-shaped supporting unit 48. The barrel-shaped supporting unit 48 is formed of an insulating material and extends upward in a vertical direction from the bottom portion 12b. Also, a conductive barrel-shaped supporting unit 50 is provided on an outer circumferential surface of the barrel-shaped supporting unit 48. The barrel-shaped supporting unit 50 extends upward in a vertical direction from the bottom portion 12b of the processing container 12 along the outer circumferential surface of the barrel-shaped supporting unit 48. An exhaust path 51 having an annular shape is formed between the barrel-shaped supporting unit 50 and the side wall 12a.

A baffle plate 52 having an annular shape is attached to a top portion of the exhaust path 51, wherein a plurality of through holes are formed in the baffle plate 52. An exhaust device 56 is connected to a bottom portion of the exhaust hole 12h via an exhaust pipe 54. The exhaust device 56 includes a vacuum pump such as a turbo molecular pump. The processing space S inside the processing container 12 may be depressurized to a desired vacuum level by the exhaust device 56.

The base 14a also serves as a high frequency electrode. A high frequency power source 58 for radio frequency (RF) bias is electrically connected to the base 14a via a matching unit 60 and a power feed rod 62. The high frequency power source 58 outputs high frequency power with a predetermined magnitude, wherein the high frequency power has a constant frequency that is suitable for controlling energy of ions dragged onto the object to be processed W, for example, 13.65 MHz. The matching unit 60 accommodates a matcher for matching impedance at the high frequency power source 58 and impedance at a load mainly such as an electrode, plasma, and the processing container 12. The matcher includes a blocking condenser for generating self-bias.

The electrostatic chuck 15, which is a holding member for holding the object to be processed W, is provided on a top surface of the base 14a. The electrostatic chuck 15 holds the object to be processed W by using electrostatic adsorption power. The focus ring 17 is provided outside the electrostatic chuck 15 in a radial direction to annularly surround the object to be processed W and the electrostatic chuck 15.

The electrostatic chuck 15 includes an electrode 15d, an insulating film 15e, and an insulating film 15f. The electrode 15d is formed of a conductive film and is provided between the insulating film 15e and the insulating film 15f. A direct current (DC) power source 64 having a high voltage is electrically connected to the electrode 15d via a switch 66 and a covered wire 68. The electrostatic chuck 15 may hold the object to be processed W due to coulomb's force generated by a DC voltage applied from the DC power source 64.

A coolant chamber 14g having an annular shape and extending in a circumferential direction is provided inside the base 14a. A coolant having a predetermined temperature, for example, a cooling water, is circularly-supplied to the coolant chamber 14g from a chiller unit (not shown) via pipes 70 and 72. A heat transferring gas of the electrostatic chuck 15, for example, He gas, is supplied between a top surface of the electrostatic chuck 15 and a rear surface of the object to be processed W via a gas supplying pipe 74 according to a temperature of the coolant.

In the plasma processing apparatus 10 configured as described above, gas is supplied into the processing space S in a direction of the axial line X from the through hole 20h of the dielectric window 20 via the pipe 36 and a through hole of the injector 41. Also, gas is supplied below the through hole 20h toward the axial line X from the gas supplying unit 42. Also, microwaves are introduced into the processing space S and/or the through hole 20h from the antenna 18 via the dielectric window 20. Thus, plasma is generated in the processing space S and/or the through hole 20h. As such, according to the plasma processing apparatus 10, plasma may be generated without applying a magnetic field. In the plasma processing apparatus 10, the object to be processed W held on the stage 14 may be processed by plasma of the processing gas.

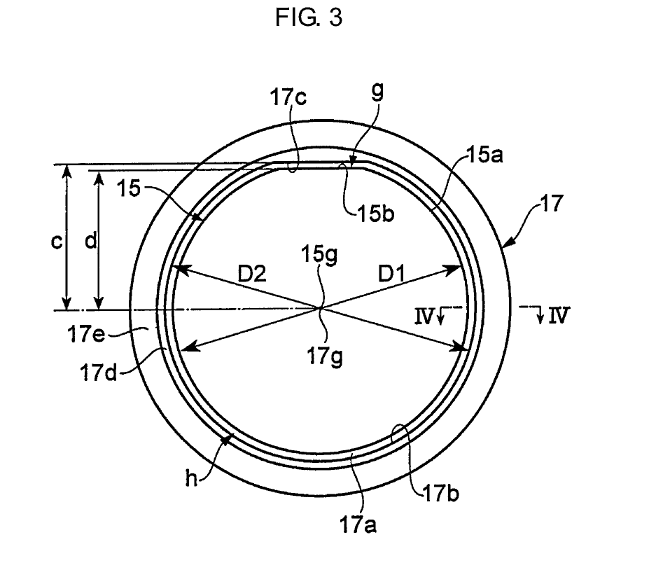

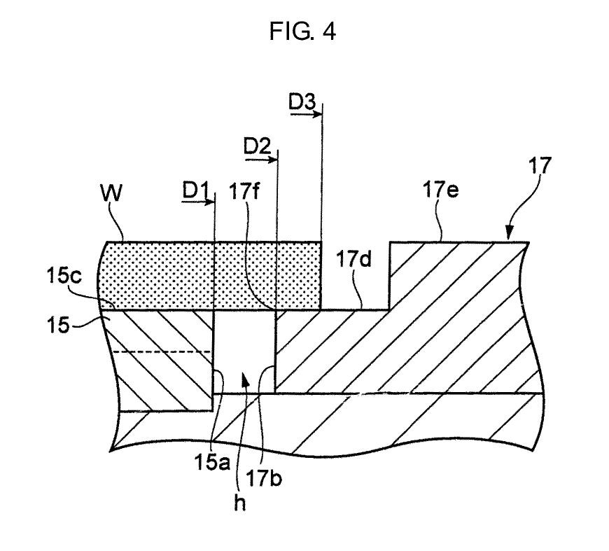

Hereinafter, the electrostatic chuck 15 and the focus ring 17 may be described in detail with reference to FIGS. 3 and 4. FIG. 3 is a plan view of the electrostatic chuck 15 and the focus ring 17 seen from a direction of the axial line X.

The electrostatic chuck 15 is formed of a dielectric material such as aluminum oxide (Al₂O₃) or yttrium oxide (Y₂O₃) and has an approximately disc shape. The electrostatic chuck 15 has a cross-section 15a. In the present embodiment, the cross-section 15a partially includes a flat cross-section 15b. The electrostatic chuck 15 includes a predetermined outer diameter (diameter) D1.

The focus ring 17 is loaded on the base 14a to surround the cross-section 15a of the electrostatic chuck 15. The focus ring 17 is formed of, for example, silicon oxide (SiO₂) and has an annular plate. A hole 17a having an inner diameter D2 is formed in the focus ring 17. An inner wall surface 17b defining the hole 17a partially includes a flat wall surface 17c facing the flat cross-section 15b of the electrostatic chuck 15.

A gap h is defined between the cross-section 15a of the electrostatic chuck 15 and the inner wall surface 17b, that is, an inner circumference of the focus ring 17. The outer diameter D1 of the electrostatic chuck 15 and the inner diameter D2 of the focus ring 17 are set such that the gap h may be equal to or less than 350 μm in a room temperature environment, for example, 25° C. The focus ring 17 is disposed on the base 14a such that a position of a central axis 17g of the focus ring 17 is approximately the same as that of a central axis 15g of the electrostatic chuck 15.

A gap g is defined between the flat cross-section 15b of the electrostatic chuck 15 and the flat wall surface 17c of the focus ring 17. If the position of the central axis 17g of the focus ring 17 is the same as that of the central axis 15g of the electrostatic chuck 15, the gap g is defined by distances d and c. The distance d is defined by a distance between the flat cross-section 15b of the electrostatic chuck 15 and a plane parallel to the flat cross-section 15b and including the central axis 15g. The distance c is defined by a distance between the flat wall surface 17c of the focus ring 17 and a plane parallel to the flat wall surface 17c and including the central axis 17g. The distance d of the electrostatic chuck 15 and the distance c of the focus ring 17 are set such that that the gap g may be equal to or less than 350 μm in a room temperature environment, for example, 25° C.

FIG. 4 is an enlarged partial cross-sectional view taken along a line IV-IV of FIG. 3 and showing the electrostatic chuck 15 and the focus ring 17 according to an embodiment of the present invention. The focus ring 17 includes a first area 17d including an inner circumference 17f, and a second area 17e positioned outside of the first area 17d. The inner wall surface 17b of the focus ring 17 faces the cross-section 15a of the electrostatic chuck 15.

The object to be processed W is held on a surface 15c of the electrostatic chuck 15. Since the outer diameter D1 of the electrostatic chuck 15 is smaller than an outer diameter D3 of the object to be processed W, an outer circumferential portion of the object to be processed W protrudes from the cross-section 15a of the electrostatic chuck 15 in a direction perpendicular to the axial line X.

The first area 17d of the focus ring 17 is provided along a surface extending from the surface 15c of the electrostatic chuck 15. Alternatively, the first area 17d may be provided below the surface extending from the surface 15c of the electrostatic chuck 15. A partial area of the first area 17d of the focus ring 17 is covered by the object to be processed W. Also, the gap h and the gap g between the electrostatic chuck 15 and the focus ring 17 are covered by the object to be processed W. Accordingly, if the object to be processed W is held on the electrostatic chuck 15, plasma is prevented from entering the gap h and the gap g.

Also, the second area 17e of the focus ring 17 is provided above the surface 15c of the electrostatic chuck 15. Accordingly, plasma may be uniformly distributed on a surface of the object to be processed W.

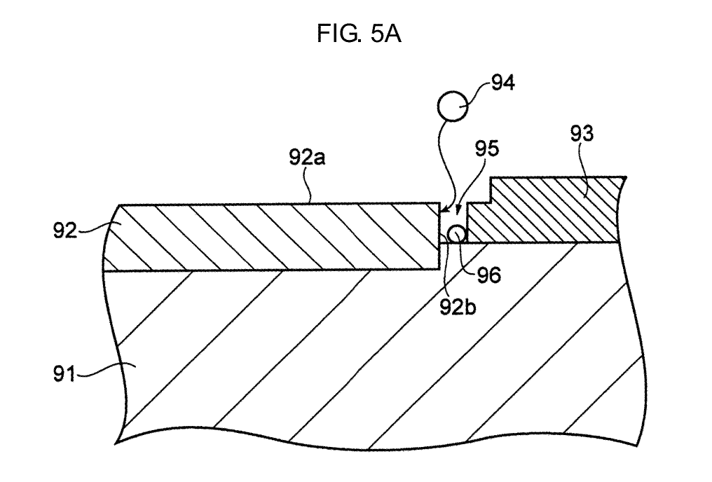

A phenomenon occurring when an electrostatic chuck 92 and a focus ring 93 according to a comparative example are used will be described with reference to FIG. 5. A gap 95 between the electrostatic chuck 92 and the focus ring 93 shown in FIG. 5A is, for example, 500 μm. While an object to be processed is not adsorbed onto a surface 92a of the electrostatic chuck 92, a wafer less dry cleaning (WLDC) process is performed. At this time, a mixture gas (SF₆/O₂) of sulfur hexafluoride and oxygen is used as a processing gas. If a plasma 94 enters the gap 95 between the electrostatic chuck 92 and the focus ring 93, a cross-section 92b of the electrostatic chuck 92 formed of aluminum oxide (Al₂O₃) is fluorinated by fluorine contained in the processing gas, thereby generating minute particles 96 of aluminum fluoride (AIF). It is thought that the minute particles 96 accumulate in the gap 95 or adhere to the surface 92a of an outer circumferential portion of the electrostatic chuck 92.

As shown in FIG. 5B, while the minute particles 96 are adhered to the surface 92a of the outer circumferential portion of the electrostatic chuck 92, if an object to be processed 97 is adsorbed onto the surface 92a of the electrostatic chuck 92, the minute particles 96 are caught between the object to be processed 97 and the surface 92a of the electrostatic chuck 92. Here, if high frequency power is supplied to a base 91, current intensely flows via the particles 96, and thus arcing may occur. If an electrode included in the electrostatic chuck 92 is exposed due to generation of arcing, a DC voltage may not be applied to the electrostatic chuck 92, and thus the object to be processed 97 may not be adsorbed by the electrostatic chuck 92.

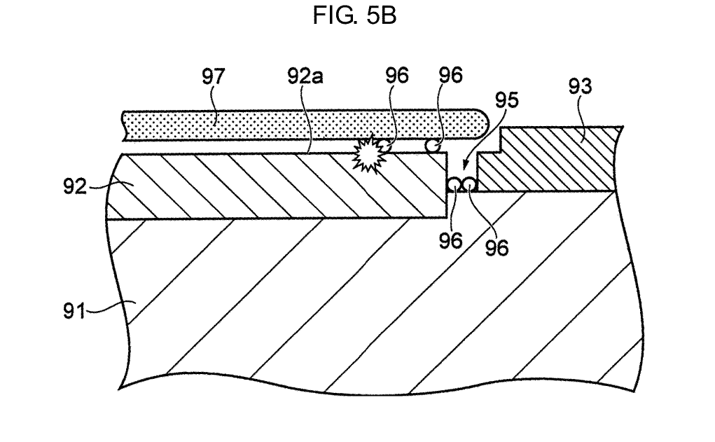

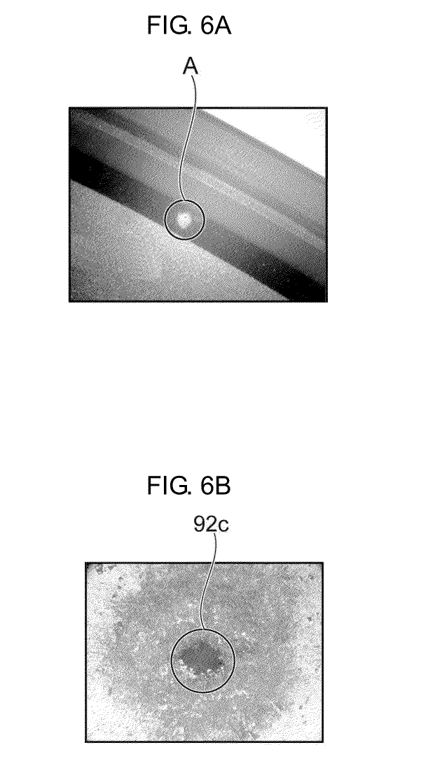

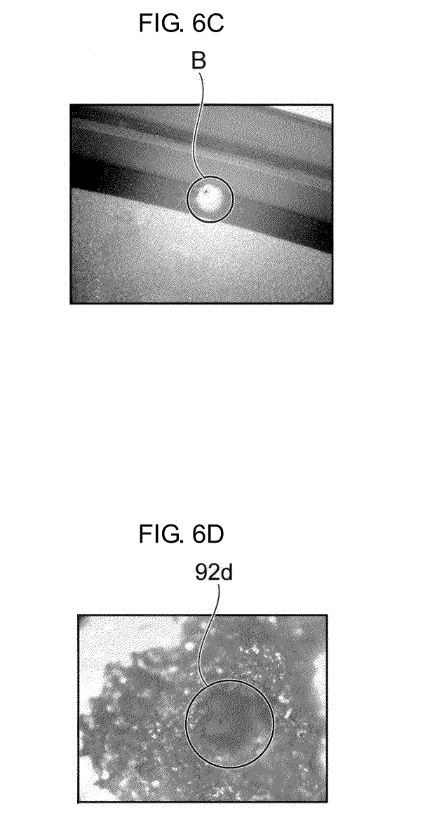

After the object to be processed 97 is processed by using the electrostatic chuck 92 and the focus ring 93 according to a comparative example, a state of the surface 92a of the electrostatic chuck 92 are observed. A result indicates that minute particles containing aluminum, fluorine and oxygen are adhered to the gap 95 between the electrostatic chuck 92 and the focus ring 93. FIG. 6A is an image showing a part of the surface 92a of the electrostatic chuck 92. FIG. 6B is an enlarged image showing a part A of FIG. 6A. Referring to FIG. 6B, a hole 92c considered to be generated due to arcing is formed in the surface 92a. Also, FIG. 6C is an image obtained by capturing a part of a separate area of the surface 92a of the electrostatic chuck 92. FIG. 6D is an enlarged image of a part B of FIG. 6C. Referring to FIG. 6D, similarly to the hole 92c shown in FIG. 6B, a hole 92d considered to be generated due to arcing is formed in the surface 92a.

In the plasma processing apparatus 10 according to the present embodiment, the gap h and the gap g each of which is equal to or less than 350 μm are defined between the electrostatic chuck 15 and the focus ring 17, and thus plasma is prevented from entering the gap h and the gap g, thereby preventing generation of minute particles. Accordingly, an extraneous material adhering to an outer circumferential portion of the electrostatic chuck 15 may be prevented from being generated. Also, since generation of an extraneous material may be prevented, generation of arcing may be prevented. Accordingly, poor adsorption of the electrostatic chuck 15 may be prevented from occurring.

In this regard, a relationship between sizes of the gap h and the gap g and plasma will be described. In order for plasma to exist in the gap h and the gap g, it is required that sizes of the gap h and the gap g be sufficiently larger than a Debye length λ_{D} (see Equation 1 below).

$${λ}_{D} ( cm ) = 7.43 \times {10}^{2} \sqrt{\frac{{T}_{e} ( eV )}{{n}_{0} ( {cm}^{- 3} )}} \qquad ( 1 )$$

In Equation 1, Tₑ denotes an electron temperature, and nₒ denotes an electron density. When an electric field is applied to plasma, free electrons move by thermal motion to block the electric field. The Debye length λ_{D} is a length representing an order of a length blocking the electric field. Thus, an electrical neutrality of plasma is not obtained in a space smaller than the Debye length λ_{D}. In order for plasma to exist in the gap h and the gap g, it is required that a distance between the electrostatic chuck 15 and the focus ring 17, that is, sizes of the gap h and the gap g, be larger than two or three times the Debye length λ_{D} in consideration of a sheath length. In other words, if the sizes of the gap h and the gap g are set to be equal to or less than two or three times the Debye length λ_{D}, plasma is prevented from entering the gap h and the gap g. Accordingly, generation of minute particles due to plasma may be prevented.

For example, if Tₑ is 1.5 eV and nₒ is 6×10⁹ cm⁻³, the Debye length λ_{D} is 117 μm. Thus, if the sizes of the gap h and the gap g are equal to or less than three times the Debye length λ_{D}, that is, equal to or less than 350 μm, plasma may be prevented from being generated in the gap h and the gap g.

Hereinafter, a detailed embodiment will be described. In the present embodiment, the outer diameter D3 of the object to be processed W is 300 mm. As one embodiment, in a temperature environment of 25° C., sizes of the electrostatic chuck 15 containing aluminum oxide (Al₂O₃) and the focus ring 17 containing silicon oxide (SiO₂) are set as follows.

The outer diameter D1 of the electrostatic chuck 15: 297.9 mm

The inner diameter D2 of the focus ring 17: 298.1 mm

The distance c: 148.1 mm

The distance d: 148 mm

When the electrostatic chuck 15 and the focus ring 17 are set to have the above-described sizes, the gap h is 0.1 mm (100 μm), and the gap g is 0.1 mm (100 μm). Also, if the electrostatic chuck 15 and the focus ring 17 having the above-described sizes are heated to 80° C., the gap h is 0.029 mm (29 μm), and the gap g is 0.029 mm (29 μm). As such, even if the electrostatic chuck 15 and the focus ring 17 are heated to 80° C., the electrostatic chuck 15 does not contact the focus ring 17.

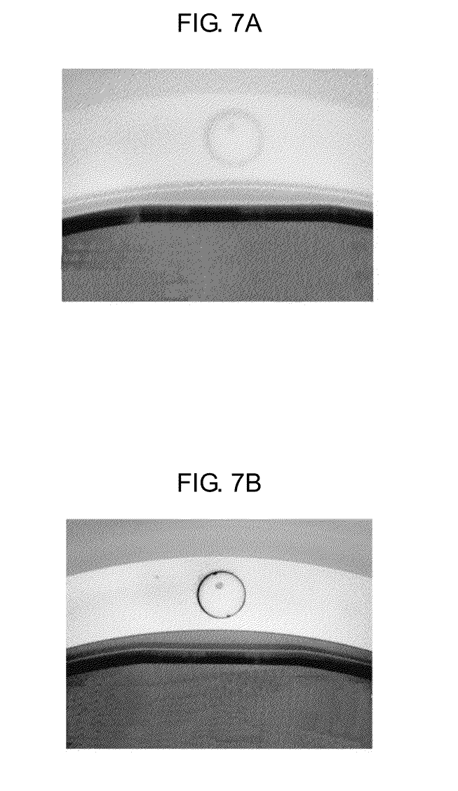

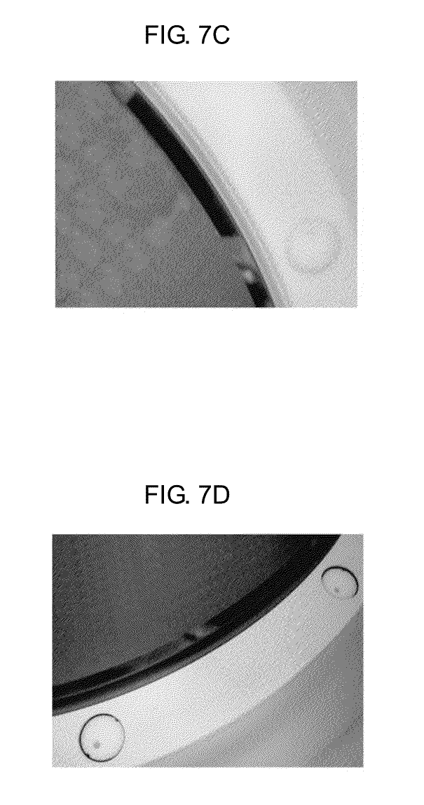

After processing the object to be processed W by using the electrostatic chuck 15 and the focus ring 17 having the above-described sizes, a state of the surface 15c of the electrostatic chuck 15 is observed. FIGS. 7A to 7D are images obtained by capturing parts of the electrostatic chuck 15 and the focus ring 17. The holes 92c and 92d, which are shown in the surface 92a of the electrostatic chuck 92 according to the comparative example of the present invention, are not shown in the electrostatic chuck 15 and the focus ring 17 according to the present embodiment. Also, minute particles adhering to surfaces of the electrostatic chuck 15 and the focus ring 17 is not shown when examining with the naked eye. Thus, by allowing the gap h and the gap g to have a size of 0.1 mm (100 μm), an extraneous material adhering to the outer circumferential portion of the electrostatic chuck 15 may be prevented from being generated.

While this invention has been particularly shown and described with reference to exemplary embodiments thereof, it will be understood by those skilled in the art that various changes in form and details may be made therein without departing from the spirit and scope of the invention as defined by the appended claims. For example, the idea of the present invention may be applied to an arbitrary plasma processing apparatus such as a parallel flat electrode type plasma processing apparatus as well as a microwave plasma processing apparatus.

Also, for example, a focus ring may be formed of silicon as well as silicon oxide, according to a type of processing gas.

As described above, according to the present invention, a plasma processing apparatus capable of preventing generation of an extraneous material is provided.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A plasma processing apparatus comprising:
a processing container which defines a processing space;
a gas supplying unit which supplies a processing gas to the processing space;
an introducing unit which introduces energy for generating plasma of the processing gas;
a holding member which holds an object, has a surface formed of a dielectric material, and is provided inside the processing space; and
a focus ring which is provided to surround a cross-section of the holding member, wherein a gap equal to or less than about 350 μm is defined between the cross-section of the holding member and the focus ring.

2. The plasma processing apparatus of claim 1, wherein the focus ring comprises a first area comprising an inner circumference of the focus ring, and a second area positioned outside of the first area, the first area is provided along a surface extending from a top surface of the holding member or is provided below the extending surface, and the second area is provided above the top surface of the holding member.
